(19) United States
(12) Patent Application Publication
(10) Pub. No.: US 2023/0194160 A1
(43) Pub. Date: Jun. 22, 2023

(54) LIQUEFIED GAS STORAGE FACILITY

(71) Applicant: L'Air Liquide, Societe Anonyme pour l'Etude et l'Exploitation des Procedes Georges Claude, Paris (FR)

(72) Inventors: Francois LAGOUTTE, Sassenage (FR); Jean-Marc BERNHARDT, Sassenage (FR); Remi NICOLAS, Sassenage (FR)

(73) Assignee: L'Air Liquide, Societe Anonyme pour l'Etude et l'Exploitation des Procedes Georges Claude, Paris (FR)

(21) Appl. No.: 17/919,423

(22) PCT Filed: Mar. 23, 2021
(86) PCT No.: PCT/EP2021/057357

§ 371 Date: Oct. 17, 2022

(30) Foreign Application Priority Data
Apr. 17, 2020 (FR) FR 2003881

(51) Int. Cl. F25J 1/00; F25J 1/02

(52) U.S. Cl. CPC F25J 1/001; F25J 1/005; F25J 1/0065; F25J 1/0067; F25J 1/0204; F25J 1/0212; F25J 1/0244; F25J 1/0279; F17C 2201/0104; F17C 2201/032; F17C 2221/012; F17C 2227/0355; F17C 2227/0372; F25J 2290/62

(57) ABSTRACT

The invention relates to a liquefied gas storage facility, in particular for liquid hydrogen, comprising a liquefied gas tank intended to contain gas in liquid form and a gaseous phase, a device for cooling the contents of the tank, the cooling device comprising at least a first refrigerator with a cycle for refrigerating a cycle gas, said first refrigerator comprising, arranged in series in a cycle circuit: a member for compressing the cycle gas, a member for cooling the cycle gas, a member for expanding the second cycle gas and a member for reheating the expanded cycle gas, the cooling device comprising a first heat transfer fluid loop comprising a first end exchanging heat with a cold end of the first refrigerator and a second end comprising a first heat exchanger located in the tank, the first heat transfer fluid loop comprising a member for circulating the heat transfer fluid, characterized in that the first heat exchanger exchanges heat directly with the inside of the tank, that is to say that the first heat exchanger exchanges heat directly with the fluid which surrounds it in the tank.

This application is a § 371 of International PCT Application PCT/EP2021/057357, filed Mar. 23, 2021, which claims § 119(a) foreign priority to French patent application FR 2003881, filed Apr. 17, 2020.

### BACKGROUND

### Field of the Invention

The invention relates to an installation for storing liquefied gas, in particular liquid hydrogen.

The invention relates more particularly to an installation for storing liquefied gas, in particular liquid hydrogen, comprising a liquefied gas reservoir intended to contain gas in liquid form and a gaseous phase, a device for cooling the contents of the reservoir, the cooling device comprising at least one first refrigerator with a cycle of refrigeration of a cycle gas, said first refrigerator comprising, disposed in series in a cycle circuit: a member for compressing the cycle gas, a member for cooling the cycle gas, a member for expanding the second cycle gas and a member for heating the expanded cycle gas, the cooling device comprising a first heat transfer fluid loop comprising a first end in heat exchange with a cold end of the first refrigerator and a second end comprising a first heat exchanger situated in the reservoir, the first heat transfer fluid loop comprising a member for circulating the heat transfer fluid.

The invention can relate in particular to an installation for storing liquefied gas, in particular liquid hydrogen transported in particular by boat. Thus, the invention can also relate to a boat comprising such an installation.

The invention relates in particular to a system for storing liquid hydrogen over a long period, taking into account the filling and withdrawal phases, without loss by evaporation, which implements technologies minimizing the number of items of equipment and the maintenance required.

### Related Art

The transport of cryogenic fluid, in particular liquid hydrogen in large quantities, is likely to grow, particularly transport by sea, for journeys that can last several weeks.

For large reservoirs (several thousand m3), the cumulative thermal inputs generate significant evaporation of the cargo. This causes an increase in pressure. This problem is similar to that encountered on tanks of methane tankers.

Specifically, such an installation is subject to the following phenomena:

significant evaporation during a phase of filling the reservoir, due to the arrival of the liquid on relatively hot walls,

natural thermal inputs, particularly during the full or empty transport phase,

a drop in pressure during the withdrawal phases.

Some of the vapors can be used for energy production purposes (via a fuel cell), but a solution that makes it possible to recondense these vapors or eliminate the evaporation is preferable.

Document U.S. Pat. No. 3,302,416 describes such an installation in which the liquid phase of the natural gas is pumped and brought into heat exchange with a cooling heat exchanger inside a closed chamber housing the heat exchanger.

This solution makes it possible to cool the liquid phase of the reservoir but does not allow satisfactory regulation of the pressure in the reservoir during the filling phases.

### SUMMARY OF THE INVENTION

An aim of the present invention is to remedy all or some of the drawbacks of the prior art that are set out above.

To this end, the installation according to the invention, which is otherwise in accordance with the generic definition thereof given in the above preamble, is essentially characterized in that the first heat exchanger is in direct heat exchange with the inside of the reservoir, i.e. the first heat exchanger is in direct heat exchange with the fluid that surrounds it in the reservoir.

Furthermore, embodiments of the invention may have one or more of the following features:
the first heat exchanger is situated in the upper part of the reservoir,
the second end of the first heat transfer fluid loop comprises a second heat exchanger connected in parallel to the first heat exchanger, the second heat exchanger being situated in the lower part of the reservoir and in direct heat exchange with the inside of the reservoir, i.e. the exchanger is in direct heat exchange with the fluid that surrounds it in the reservoir,
the first heat transfer fluid loop comprises a system of one or more valves for regulating the flow rate of heat transfer fluid in the first heat exchanger and/or in the second heat exchanger,
the circulation member comprises a compressor or a pump of the cryogenic type,
the heat transfer fluid contains helium and/or hydrogen,
the first end of the first heat transfer fluid loop is in heat exchange with a cold end of the first refrigerator at a heat exchanger ensuring a counter-current heat exchange between the heat transfer fluid and the cycle gas of the first refrigerator,
the installation comprises a line for supplying fluid to be liquefied that is intended to be connected to a gas source, said line being in heat exchange with the cycle gas of the first refrigerator, said line preferably opening into the reservoir,
the installation comprises a line of cryogenic liquid in heat exchange with the member for cooling the cycle gas so as to heat said liquid,
the cooling device comprises a second refrigerator with a cycle of refrigeration of a cycle gas, said second refrigerator comprising, disposed in series in a cycle circuit: a member for compressing the cycle gas, a member for cooling the cycle gas, a member for expanding the cycle gas and a member for heating the expanded cycle gas, the installation comprising a system for heat exchange between the cycle gas of the second refrigerator and the cycle gas of the first refrigerator,
the system for heat exchange between the cycle gas of the second refrigerator with a refrigeration cycle and the cycle gas of the first refrigerator with a refrigeration cycle comprises a second heat transfer fluid loop comprising a first end in heat exchange with a portion of the cycle circuit of the second refrigerator, and a second end in heat exchange with a portion of the cycle circuit of the first refrigerator,
the first end of the second heat transfer fluid loop is in heat exchange with a portion of the cycle circuit of the second refrigerator at at least one heat exchanger, the second end of the second heat transfer fluid loop being in heat exchange with a portion of the cycle circuit of the first refrigerator at at least one heat exchanger,
the second heat transfer fluid loop comprises a member for circulating the heat transfer fluid such as a pump.

The invention can also relate to a storage method using such an installation.

The invention can also relate to any alternative device or method comprising any combination of the features above or below within the scope of the claims.

### BRIEF DESCRIPTION OF THE FIGURES

Further particular features and advantages will become apparent upon reading the following description, which is provided with reference to the figures, in which:

FIG. 1 shows a schematic and partial view illustrating a first example of the structure and operation of the installation according to the invention;

FIG. 2 shows a schematic and partial view illustrating a second example of the structure and operation of the installation according to the invention.

### DETAILED DESCRIPTION OF THE INVENTION

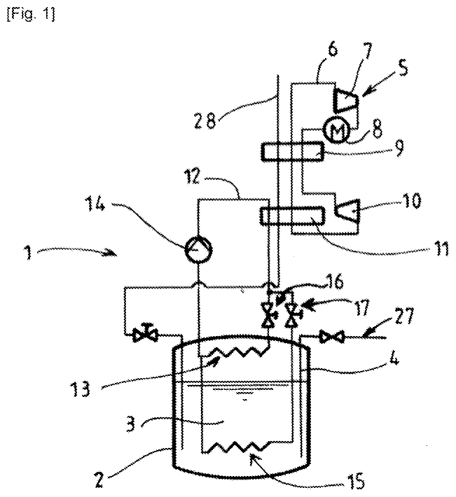

The installation 1 for storing liquefied gas (in particular liquid hydrogen) that is shown in FIG. 1 comprises a liquefied gas reservoir 2 intended to contain gas in liquid form 3 in the lower part and a gaseous phase 4 in the upper part. The installation 1 comprises a device for cooling the contents of the reservoir 2 thus making it possible to regulate the pressure therein.

This cooling device comprises a refrigerator 5 with a cycle of refrigeration of a cycle gas. This cycle gas preferably contains helium and/or hydrogen and/or neon and/or nitrogen and/or any other suitable gas.

This refrigerator 5 has, disposed in series in a cycle circuit 6: a member 7 for compressing the cycle gas (such as one or more compressors), a member 8, 9 for cooling the cycle gas (for example one or more heat exchangers), a member 10 for expanding the second cycle gas (one or more turbines or valves) and a member 11, 9 for heating the expanded cycle gas (for example one or more heat exchangers).

For example, this refrigerator 5 is configured to produce cold at a temperature between 15 K and 25 K, as well as sufficient driving pressure to ensure the circulation of the cycle gas in the cycle circuit 6.

Preferably, the cycle gas performs, in this refrigerator 5, a thermodynamic cycle referred to as a reverse Brayton thermodynamic cycle. Preferably, the one or more compressors 7 are of the centrifugal type (and the turbines of the centripetal type) and have the particular feature of operating without oil. According to one embodiment, the one or more turbines 10 can be assembled on the same shaft as the compressor 7 in order to recover energy.

The cooling device further comprises a heat transfer fluid loop 12 comprising a first end in heat exchange with a cold end 11 of the first refrigerator and a second end comprising at least one first heat exchanger 13 situated in the reservoir 2. This heat transfer fluid loop 12 comprises a member 14 for circulating the heat transfer fluid, for example a compressor or a cryogenic pump.

This heat transfer fluid can comprise helium and/or hydrogen for example.

This cooling cycle of the refrigerator 5 can be a combination of a plurality of cycles in cascade. For example a first cycle using a mixture of nitrogen, helium and/or neon, followed by a second cycle containing helium and/or hydrogen

This pump 14 (or cryogenic compressor) is configured to operate at these very low temperatures and preferably does not require any oil or grease for its operation.

The first end of the heat transfer fluid loop 12 is in heat exchange with a cold end of the first refrigerator for example at a heat exchanger 11 ensuring a counter-current heat exchange between the heat transfer fluid and the cooled and expanded cycle gas of the first refrigerator 5.

In the example shown, the installation 1 comprises two heat exchangers 13, 15 in the reservoir 2, one in the top part and one in the bottom part.

Of course, a configuration with only one of these exchangers 13, 15 (or condensers) can be provided.

Similarly, it is possible to provide a plurality of upper heat exchangers 13 and/or a plurality of lower heat exchangers 15 (especially in the case of a reservoir 2 of very large dimensions).

The two heat exchangers 13, 15 can be connected in parallel at the second end of the heat transfer fluid loop 12. The heat transfer fluid loop 12 preferably comprises a system of one or more regulating valves 16, 17 for controlling the flow rate of heat transfer fluid in the first heat exchanger 13 and/or in the second heat exchanger 15.

The one or more exchangers 13, 15 are in direct heat exchange with the fluid inside the reservoir 2, i.e. these exchangers ensure direct heat exchange with the fluid that surrounds them in the reservoir 2. This means that the one or more exchangers 13, 15 are immersed directly in the liquid or gaseous phases of fluid stored in the reservoir 2.

This allows efficient heat exchange between the heat transfer fluid and the fluid in the reservoir 2 without requiring a pump and transfer circuit with casing inside the reservoir 2.

The reservoir 2 is configured to contain, for example, a determined quantity of liquid hydrogen, by integrating equipment for regulating the pressure of the liquid, in order to eliminate losses by evaporation. The reservoir 2 can be of any type (membrane, sphere or other). It comprises in particular at least one filling and/or withdrawal line 27.

Thus, in the event of too high a pressure in the reservoir 2 with respect to a determined setpoint, the heat transfer fluid can be made to circulate in the upper heat exchanger 13 at a temperature lower than the dew point of the fluid in the reservoir 2. This has the effect of recondensing the vapors and causing the pressure in the reservoir 2 to drop.

The heat transfer fluid can also be allowed to circulate in the lower exchanger 15 at a temperature lower than the temperature of the liquid in the reservoir 2.

This secondary cycle can be a combination of a plurality of cycles in cascade. For example a first cycle using a mixture of nitrogen, helium and/or neon, followed by a second cycle containing helium and/or hydrogen

Similarly, according to one embodiment, the heat transfer fluid can be made to circulate in the lower heat exchanger 15 at a temperature higher than the temperature of the liquid contained in the reservoir 2. This makes it possible to evaporate some of the liquid and to raise the pressure in the reservoir 2. This procedure can in particular be used when it is desired to withdraw liquid from the reservoir 2 by means of a pressure differential.

Thus, the installation 1 makes it possible to use either the upper heat exchanger 13 to heat the gaseous phase, or the lower heat exchanger 15 to evaporate liquid, in order to cause the pressure in the reservoir to increase.

In order to increase the temperature of the heat transfer fluid, the refrigerator 5 can for example be switched to a mode in which it makes it possible to reach a target temperature of the heat transfer fluid (stop, degraded mode, in particular rotation of a compressor or turbine in the opposite direction).

The installation 1 makes it possible to minimize the number of modules necessary to fulfill the functions (no de-oiling system, no gas buffer storage).

As illustrated in FIG. 1, the refrigerator 5 can also be used to cool and liquefy a fluid flow that is intended to supply, for example, the reservoir 2. Thus, a line 28 supplied with fluid to be liquefied (from a gaseous source for example) can be provided and can be in heat exchange with the heat exchangers 9, 10 of the refrigerator 5 and can open into the reservoir 2.

The heat exchanger 9 can also be supplied with an external fluid, for example the vaporization (boil-off) gases from a cryogenic reservoir installed near the system.

Thus an additional cryogenic fluid (which is liquid in particular) can also be heated in the one or more heat exchangers 9 of the refrigerator 5. For example, when the installation is situated on a boat for example, it is possible to reuse the cold vapors from a neighboring tank (boil off for example) from which the frigories can be recovered.

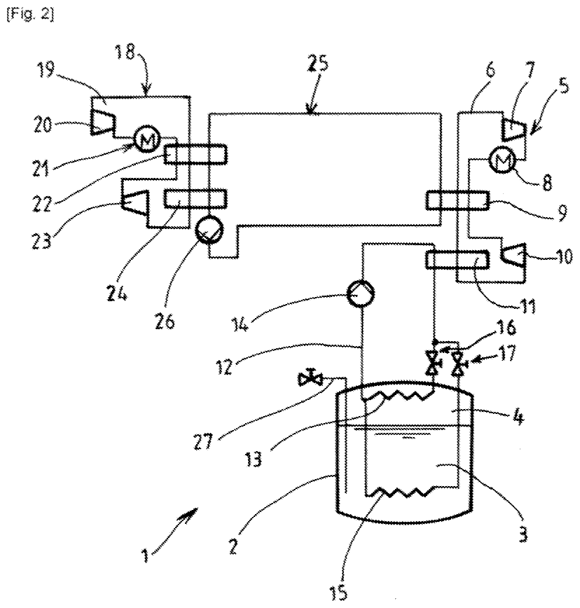

In the embodiment in [FIG. 2], the cooling device comprises a second refrigerator 18 with a cycle of refrigeration of a cycle gas. This second refrigerator 18 comprises, disposed in series in a cycle circuit 19: a member 20 for compressing the cycle gas, a member 21, 22 for cooling the cycle gas, a member 23 for expanding the cycle gas and a member 24 for heating the expanded cycle gas. The structure may be of the same type as for the first refrigerator 5 described above.

The installation 1 comprises a system 9, 25 for heat exchange between the cycle gas of the second refrigerator 18 and the cycle gas of the first refrigerator 5 with a cycle.

This heat exchange system preferably comprises a second heat transfer fluid loop 25 comprising a first end in heat exchange with a portion of the cycle circuit 19 of the second refrigerator 18, and a second end in heat exchange with a portion 9 of the cycle circuit 6 of the first refrigerator 5.

The first end of the second heat transfer fluid loop 25 can be in heat exchange with a portion of the cycle circuit 19 of the second refrigerator 18 at at least one heat exchanger 22, 24 of the refrigerator 18 (for example counter-current with the cycle gas of this second refrigerator 18). The second end of the second heat transfer fluid loop 25 can be in heat exchange with a portion 9 of the cycle circuit 6 of the first refrigerator 5 at at least one heat exchanger 11, 9 (for example counter-current to the cycle gas).

This second refrigerator 18 can thus be provided to ensure pre-cooling of the cycle gas of the first refrigerator 5.

This cycle gas of the second refrigerator 18 can comprise, for example, a mixture of nitrogen, helium and/or neon. The heat transfer fluid may comprise for example: nitrogen, helium and/or neon, or any other suitable gas or gas mixture.

Of course, the system for heat exchange between the cycle gas of the second refrigerator and the cycle gas of the first refrigerator is not limited to the example above. Thus, for example, any other heat exchange between the two refrigerators and in particular a direct heat exchange between the two refrigerators can be envisaged.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising,” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-12. (canceled)

13. An installation for storing liquefied gas, comprising:
a) a liquefied gas reservoir intended to contain gas in liquid form and a gaseous phase; and
b) a cooling device for cooling the contents of the reservoir, the cooling device comprising:
i) at least one first refrigerator with a cycle of refrigeration of a cycle gas, said first refrigerator comprising, disposed in series in a cycle circuit: a member for compressing the cycle gas, a member for cooling the cycle gas, a member for expanding the second cycle gas and a member for heating the expanded cycle gas; and
ii) a first heat transfer fluid loop comprising a first end in heat exchange with a cold end of the first refrigerator and a second end comprising a first heat exchanger situated in the reservoir, the first heat transfer fluid loop comprising a member for circulating the heat transfer fluid,
wherein:
the first heat exchanger is in direct heat exchange with the fluid that surrounds the first heat exchanger in the reservoir,
the second end of the first heat transfer fluid loop comprises a second heat exchanger connected in parallel to the first heat exchanger, and
the second heat exchanger is situated in the lower part of the reservoir and in direct heat exchange with the fluid that surrounds the second heat exchanger in the reservoir.

14. The installation of claim 13, wherein the first heat exchanger is situated in an upper part of the reservoir.

15. The installation of claim 14, wherein the first heat transfer fluid loop comprises a system of one or more valves for regulating a flow rate of heat transfer fluid in the first heat exchanger and/or in the second heat exchanger.

16. The installation of claim 13, wherein the circulation member comprises a cryogenic compressor or a cryogenic pump.

17. The installation of claim 13, wherein the heat transfer fluid contains helium and/or hydrogen.

18. The installation of claim 13, wherein the first end of the first heat transfer fluid loop is in heat exchange with a cold end of the first refrigerator at a heat exchanger ensuring a counter-current heat exchange between the heat transfer fluid and the cycle gas of the first refrigerator.

19. The installation of claim 13, further comprising a line for supplying fluid to be liquefied that is intended to be connected to a gas source, said line being in heat exchange with the cycle gas of the first refrigerator and opening into the reservoir.

20. The installation of claim 13, further comprising a line of cryogenic liquid in heat exchange with the member for cooling the cycle gas.

21. The installation of claim 13, wherein:
the cooling device further comprises a second refrigerator with a cycle of refrigeration of a cycle gas;
said second refrigerator comprises, disposed in series in a cycle circuit: a member for compressing the cycle gas, a member for cooling the cycle gas, a member for expanding the cycle gas and a member for heating the expanded cycle gas; and
the installation further comprises a system for heat exchange between the cycle gas of the second refrigerator and the cycle gas of the first refrigerator.

22. The installation of claim 21, wherein the system for heat exchange between the cycle gas of the second refrigerator with a refrigeration cycle and the cycle gas of the first refrigerator with a refrigeration cycle comprises a second heat transfer fluid loop comprising a first end in heat exchange with a portion of the cycle circuit of the second refrigerator and a second end in heat exchange with a portion of the cycle circuit of the first refrigerator.

23. The installation of claim 22, wherein:
the first end of the second heat transfer fluid loop is in heat exchange with a portion of the cycle circuit of the second refrigerator at at least one heat exchanger; and
the second end of the second heat transfer fluid loop is in heat exchange with a portion of the cycle circuit of the first refrigerator at at least one heat exchanger.

24. The installation of claim 23, wherein the second heat transfer fluid loop comprises a pump for circulating the heat transfer fluid.

25. The installation of claim 22, wherein the second heat transfer fluid loop comprises a pump for circulating the heat transfer fluid.
